(19) United States
(12) Patent Application Publication
(10) Pub. No.: US 2013/0263228 A1
(43) Pub. Date: Oct. 3, 2013

(54) DOCUMENT BROWSING SYSTEM, CONTROLLING METHOD THEREFOR, AND DATA SERVER

(71) Applicant: FUJIFILM CORPORATION, Tokyo (JP)

(72) Inventor: Hisayoshi TSUBAKI, Tokyo (JP)

(73) Assignee: FUJIFILM Corporation, Tokyo (JP)

(21) Appl. No.: 13/844,891

(22) Filed: Mar. 16, 2013

(30) Foreign Application Priority Data
Mar. 30, 2012 (JP) 2012-081016

(51) Int. Cl. H04L 29/06

(52) U.S. Cl. CPC H04L 63/08
USPC 726/4

(57) ABSTRACT

A method (and system and server) in which, when a mobile phone unauthorized by a data server requests an access to a document stored in the data server, the unauthorized mobile phone sends a request for access permit to an authorized mobile phone. The authorized mobile phone sends back information for temporary access to the unauthorized mobile phone. On the basis of the information for temporary access, the unauthorized mobile phone transmits a request for temporary access to the data server, upon which the data server transmits information for judgment to the authorized mobile phone. On the basis of the information for judgment, the authorized mobile phone judges whether the unauthorized mobile phone should be permitted an access to the requested document. The unauthorized mobile phone is granted a temporary access to the requested document if the document is currently displayed on the authorized mobile phone.

### BACKGROUND OF THE INVENTION

1. Field of the Invention

The present invention relates to a document browsing system, a method of controlling the document browsing system and a data server for the system.

2. Description of the Related Art

As communication terminals that communicate with data servers through the Internet to get access to document data stored in data server, many kinds of mobile terminals such as mobile phones, smart phones, and PDA (Personal Digital Assistant) terminals have recently been widely spread. These communication terminals have a display device, such as an LCD panel, for displaying data acquired from data servers. Document data stored in data servers may include Word data created on Microsoft Word, Excel data created on Microsoft Excel, CAD data created on Auto CAD, graphic data, and any kinds of image data.

Concerning a data server for internal use only, stored document data is converted to image data before sending the same to a communication terminal in response to a request for access permit from the communication terminal, in order to prevent the document data against altering or tampering. Moreover, for security reason, the intra-company data server is configured to give access permits to authorized communication terminals only. However, it is sometimes necessary for company employees to show their clients or visitors the same document as the company employees are presently viewing on their authorized mobile terminals at a meeting or conference. Not being authorized by the intra-company data server, the mobile terminals of the customers cannot receive image data of the same document data as the authorized mobile terminals of the company employees can receive from the intra-company data server. It may be possible for the visitors to view the image data displayed on the authorized mobile terminals, or use a projector or a large-screen monitor to display the image data received on an authorized communication terminal on a large screen. However, the former solution is inconvenient and inefficient, and the latter solution needs extra equipment beside mobile terminals. Both solutions cannot work for remote conference. JPA No. 2009-032212 discloses a browsing-approval file system for confidential document, wherein a data server makes judgment as to whether an application for browsing a confidential document should be approved if the application is filed by an unauthorized terminal.

In the browsing-approval file system for confidential document of the above patent document, only application-approved users are permitted browsing the confidential documents. However, once the application for approval of browsing from a user terminal has been approved by an approver of the data server, the user terminal can thereafter access the confidential document arbitrary without any approval in the prior system. This may pose a threat to the security of the system.

The present invention is to solve the above problem and provide a document browsing system and a controlling method for this system and a data server of this system, whereby the same document data may be viewed on multiple communication terminals without threatening the security of confidential document data.

The communication terminals may include mobile phones, smart phones, laptops, desktops, PDAs. The document data may include a variety of document data, including Word data, Excel data, CAD data, graphic data, PDF (Portable Document Format) data, and any kinds of image data.

### SUMMARY OF THE INVENTION

In view of the foregoing, an object of the present invention is to provide a document browsing system, a method of controlling the document browsing system and a data server for the system, wherein image data of the same document data may be displayed simultaneously on multiple communication terminals including those unauthorized by the data server without weakening the security of the data browsing system.

The present invention provides a document browsing system comprising a data server and multiple communication terminals having image data displaying function, wherein,

A. the communication terminals comprise:

an authorized communication terminal that is authorized by an authenticator of the data server; and

an unauthorized communication terminal that is not authorized by the authenticator; and

B. the data server comprises:

a storage device storing document data;

a data converter for converting the document data to image data;

the authenticator for authentication and authorization of the communication terminals;

a communicator for communicating with the multiple communication terminals and sending the image data to the authorized communication terminal; and

a communication detector for detecting the state of communication between the communication terminals, and wherein

C. the authorized communication terminal transmits information for temporary access to the unauthorized communication terminal upon receipt of a request for access permit from the unauthorized communication terminal requesting an access to the document data, the information for temporary access being used for granting the unauthorized communication terminal a temporary access permit, and exchanges information with the data server to decide whether the unauthorized communication terminal should be allowed to access the document data;

the unauthorized communication terminal transmits the request for access permit to the authorized communication terminal when requesting an access to the document data, produces a request for temporary access on the basis of the information for temporary access as received from the authorized communication terminal, and transmits the request for temporary access to the data server; and

the data server sends image data of the same document data as sent to the authorized communication terminal to the unauthorized communication terminal if the temporary access of the unauthorized communication terminal to the document data is permitted on the basis of the information exchanged between the data server and the authorized communication terminal when the request for temporary access is received from the unauthorized communication terminal and the communication detector detects that the authorized communication terminal is in communication with the unauthorized communication terminal, and the data server invalidates the temporary access permit given to the unauthorized communication terminal when the communication detector detects the end of communication between the authorized communication terminal and the unauthorized communication terminal.

In a preferred embodiment,

A1. the authorized communication terminal comprises:

a first data producer for producing the information for temporary access upon receipt of the request for access permit from the unauthorized communication terminal; and

a judging section for judging whether to grant the unauthorized communication terminal the temporary access permit or not; and

a first controller for controlling the authorized communication terminal to transmit the information for temporary access to the unauthorized communication terminal and transmit the judgment by the judging section to the data server;

A2. the unauthorized communication terminal comprises:

a second data producer for producing the request for access permit and, upon receipt of the information for temporary access from the authorized communication terminal, the request for temporary access; and

a second controller for controlling the unauthorized communication terminal to transmit the request for access permit to the authorized communication terminal and transmit the request for temporary access to the data server; and

B. the data server further comprises:

a third data producer for producing information for judgment by the judging section in the authorized communication terminal upon receipt of the request for temporary access from the unauthorized communication terminal; and

a third controller for controlling the data server to transmit the information for judgment to the authorized communication terminal, send the image data of the document data to the unauthorized communication terminal when the judgment received from the authorized communication terminal permits the access and the authorized communication terminal is in communication with the unauthorized communication terminal, and invalidate the temporary access permit at the end of communication between the authorized communication terminal and the unauthorized communication terminal.

The data server preferably transmits image data notifying non-grant of access to the unauthorized communication terminal when the judgment received from the authorized communication terminal refuses the access.

The data server preferably transmits a session ID of the document data, to which the unauthorized communication terminal is requesting the access, to the unauthorized communication terminal; the unauthorized communication terminal preferably includes the session ID in the request for access permit when transmitting the request for access permit to the authorized communication terminal; and the authorized communication terminal produces the information for temporary access including the session ID that is included in the request for access permit and ID data of the authorized communication terminal, and transmits the information for temporary access to the unauthorized communication terminal. According to this embodiment, the unauthorized communication terminal produces the request for temporary access including the session ID, the ID data of the authorized communication terminal and ID data of the unauthorized communication terminal on the basis of the information for temporary access, and transmits the request for temporary access to the data server; the data server transmits the information for judgment including the session ID included in the request for temporary access the authorized communication terminal; and the judging section permits the access if the session ID included in the information for judgment is identical with a session ID of document data which the authorized communication terminal is currently accessing, and refuses the access if the session IDs are not identical.

In another preferred embodiment,

A1. the authorized communication terminal comprises:

a first data producer for producing a request for producing information for temporary access, which is requesting the data server to produce the information for temporary access, upon receipt of the request for access permit from the unauthorized communication terminal; and

a first controller for controlling the authorized communication terminal to transmit the request for producing information for temporary access from the authorized communication terminal to the data server and, upon receipt of the information for temporary access from the data server, transmit the information for temporary access from the authorized communication terminal to the unauthorized communication terminal;

A2. the unauthorized communication terminal comprises:

a second data producer for producing the request for access permit and, upon receipt of the information for temporary access from the authorized communication terminal, the request for temporary access; and

a second controller for controlling the unauthorized communication terminal to transmit the request for access permit to the authorized communication terminal and transmit the request for temporary access to the data server; and

B. the data server further comprises:

a third data producer for producing the information for temporary access upon receipt of the request for producing information for temporary access from the authorized communication terminal; and

a third controller for controlling the data server to transmit the information for temporary access from the data server to the authorized communication terminal, grant the unauthorized communication terminal a temporary access permit upon receipt of the request for temporary access from the unauthorized communication terminal, send the image data of the document data to the unauthorized communication terminal only while the authorized communication terminal is in communication with the unauthorized communication terminal.

In a further preferred embodiment,

A1. the authorized communication terminal comprises:

a first data producer for producing the information for temporary access upon receipt of the request for access permit from the unauthorized communication terminal; and

a first controller for controlling the authorized communication terminal to transmit the information for temporary access from the authorized communication terminal to the unauthorized communication terminal and, upon receipt of authentication data from the data server and a request for authentication from the unauthorized communication terminal, transmit the authentication data to the unauthorized communication terminal;

A2. the unauthorized communication terminal comprises:

a second data producer for producing the request for access permit and the request for authentication, and the request for temporary access upon receipt of the information for temporary access from the authorized communication terminal; and

a second controller for controlling the unauthorized communication terminal to transmit the request for access permit and the request for authentication to the authorized communication terminal, and the request for temporary access and the authentication data as received from the authorized communication terminal to the data server; and

B. the data server further comprises:

a third data producer for producing the authentication data and a command to request authentication, commanding the unauthorized communication terminal to transmit the request for authentication to the authorized communication terminal; and a third controller for controlling the data server to transmit the command to request authentication to the unauthorized communication terminal upon receipt of the request for temporary access from the unauthorized communication terminal, transmit the authentication data to the authorized communication terminal and, if the authentication data from the unauthorized communication terminal is identical with the authentication data as transmitted from the data server to the authorized communication terminal, grant the unauthorized communication terminal a temporary access permit and send the image data of the document data to the unauthorized communication terminal only while the authorized communication terminal is in communication with the unauthorized communication terminal.

A method of controlling the document browsing system according to the present invention comprises:

producing a request for access permit, requesting an access to the document data, at an unauthorized communication terminal that is not authorized by the authenticator;

transmitting the request for access permit to the authorized communication terminal;

producing information for temporary access on the basis of the request for access permit from the unauthorized communication terminal, in order to grant the unauthorized communication terminal a temporary access permit;

transmitting the information for temporary access from the authorized communication terminal to the unauthorized communication terminal;

producing a request for temporary access on the basis of the information for temporary access at the unauthorized communication terminal;

transmitting the request for temporary access to the data server;

judging whether to permit the unauthorized communication terminal a temporary access to the document data on the basis of information exchanged between the data server and the authorized communication terminal;

detecting the state of communication of the authorized communication terminal at the data server;

sending image data of the same document data as sent to the authorized communication terminal to the unauthorized communication terminal if the temporary access of the unauthorized communication terminal to the document data is permitted and the communication detector detects that the authorized communication terminal is in communication with the unauthorized communication terminal when the data server receives the request for temporary access from the unauthorized communication terminal; and

invalidating the temporary access permit given to the unauthorized communication terminal when the communication detector detects the end of communication between the authorized communication terminal and the unauthorized communication terminal.

A data server of the present invention comprises:

a storage device storing document data;

a data converter for converting the document data to image data;

an authenticator image data for individual authentication and authorization of the multiple communication terminals;

a communicator for communicating with the multiple communication terminals and transmitting the image data to a communication terminal authorized by the authenticator;

a temporary authorizer for authorizing, upon receipt of a request for temporary access to the document data from an unauthorized communication terminal that is not authorized by the authenticator, as a temporarily-authorized communication terminal;

a communication detector for detecting the state of communication between the communication terminals; and

a controller for sending image data of the same document data as sent to the authorized communication terminal to the temporary unauthorized communication terminal when the communication detector detects that the temporary authorized communication terminal is in communication with the authorized communication terminal, and invalidating the temporary authorization when the communication detector detects that the temporarily-authorized communication terminal does not communicate with the authorized communication terminal.

According to the present invention, an unauthorized communication terminal can get access to the document data stored in the data server only when the authorized communication terminal and the data server authenticate the unauthorized communication terminal and grant the unauthorized communication terminal a temporary access permit. Moreover, the data server invalidates the temporary access permit when the unauthorized communication terminal is disconnected from the authorized communication terminal. Therefore, image data of the same document data may be displayed simultaneously on multiple communication terminals including those unauthorized by the data server, while assuring the security of the data browsing system.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram illustrating a document browsing system;

FIG. 2 is a block diagram illustrating electric structures of first and second mobile phones;

FIG. 3 is a plan view illustrating an LCD screen displaying first image data on a first mobile phone;

FIG. 4 is a plan view illustrating an LCD screen of a second mobile phone, displaying image data notifying non-grant of access;

FIG. 5 is a flowchart illustrating a processing sequence for the document data browsing system in accordance with a first embodiment;

FIG. 6 is a flowchart illustrating a processing sequence for the document data browsing system in accordance with a second embodiment; and

FIG. 7 is a flowchart illustrating a processing sequence for the document data browsing system in accordance with a third embodiment.

### DESCRIPTION OF THE PREFERRED EMBODIMENTS

### First Embodiment

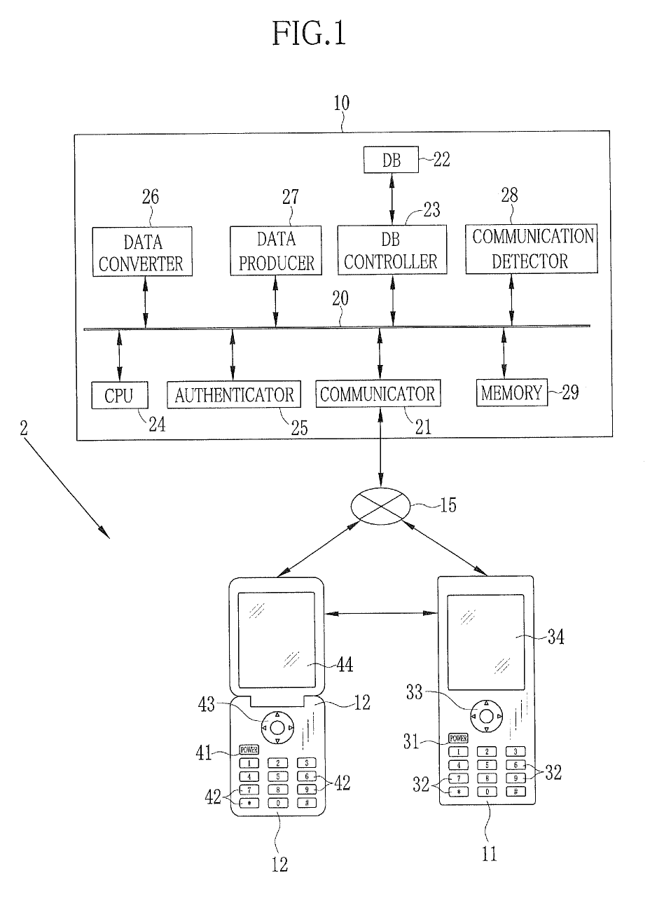

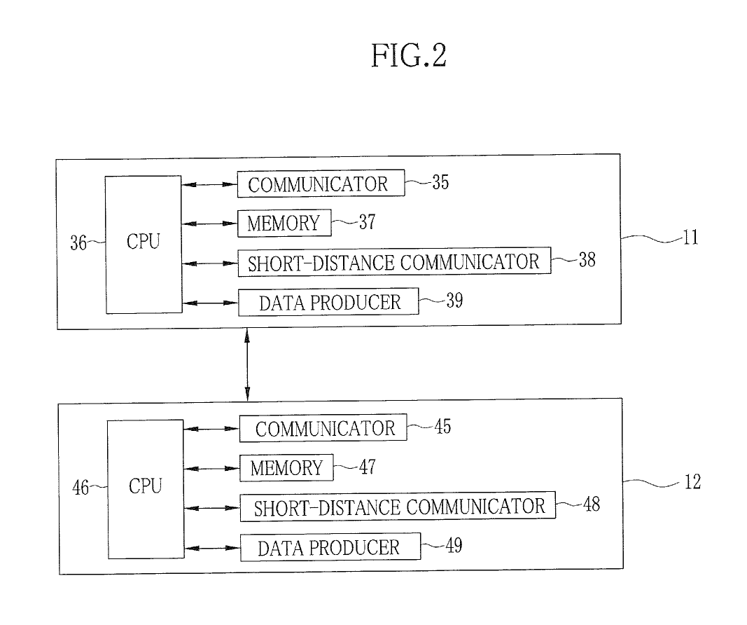

Referring to FIGS. 1 and 2, a document browsing system 2 includes a data server 10 and multiple communication terminals including a first mobile phone 11 and a second mobile phone 12. Respective mobile phones 11 and 12 are communicable with the data server 10 through the Internet 15.

The data server 10 includes a communicator 21 for establishing communication with the mobile phones 11 and 12 through the Internet 15, a database (DB) 22 storing numbers of sets of document data, including Word data, Excel data, CAD data, graphic data, PDF data etc., a database (DB) controller 23, a CPU 24, an authenticator 25 for authenticating individual communication terminals and approving an access to the document data. The data server 10 also includes a data converter 26 for converting the format of document data or the resolution of image data, a data producer 27 for producing information for use in permitting a temporary access to the document data, a communication detector 28 for detecting the state of communication between the mobile phones 11 and 12, and a memory 29. These components are connected through a data bus 20 to the CPU 2 so that the CPU 24 totally controls these components. An individual session ID is assigned to each set of document data.

The memory 29 memorizes ID data of those communication terminals which have been authorized to access the document data. The authenticator 25 judges whether ID data of a communication terminal that requests an access to the document data is included in the ID data of authorized communication terminals memorized in the memory 29. According the present embodiment, the first mobile phone 11 is of an employee of a particular company that owns the data server 10 and hence the first mobile phone 11 is authorized by the authenticator 25, whereas the second mobile phone 12 is of a client who visits the particular company and is not authorized by the authenticator 25.

The first mobile phone 11 is provided with a power button 31, multiple input buttons 32, a menu key 33 for the user to set up and select various modes and operations, and make decisions, and an LCD 34. The first mobile phone 11 is provided with a communicator 35 for wireless communication with base stations and communication with the data server 10 through the Internet 15, a CPU 36 for controlling the first mobile phone 11, a memory 37, a short-distance communicator 38 for establishing communication with another communication terminal, like the second mobile phone 12, according to the well-known Bluetooth (trade name) protocol, and a data producer 39 for producing information for use in permitting a temporary access to the document data. The LCD 34 may for example display an image in 480×854-dot pixel size, and data of the set resolution of the LCD 34 is memorized in the memory 37.

Like the first mobile phone 11, the second mobile phone 12 is provided with a power button 41, input buttons 42, a menu key 43, an LCD 44, a communicator 45 for wireless-communication and communication over the Internet, a CPU 46, a memory 47, a short-distance communicator 48, and a data producer 49. The LCD 44 may for example display an image in 240×400-dot pixel size, and data of the set resolution of the LCD 44 is memorized in the memory 47.

The mobile phones 11 and 12 are provided with a telephone mode for making a call to a fixed-line phone or another mobile phone, and a communication mode for establishing communication with the data server 10 and other mobile phones.

Telephone numbers may be registered in the memory 37. When a telephone number is read out from the memory 37 through the menu key 33, or a telephone number is input through the input buttons 32, the communicator 35 establishes a wireless communication with a base station of the mobile phone company, enabling making a call to a fixed-line phone or another mobile phone through not-shown microphone and speaker built in the first mobile phone 11.

When the communication mode is selected through the menu key 33 and an URL address of the data server 10 is entered or read out from the memory 37, the first mobile phone 11 is connected to the data server 10 through the Internet 15. In communication mode, the first mobile phone 11 transmits ID data thereof and the set resolution data of the LCD 34 to the data server 10. Since the ID data of the first mobile phone 11 is registered as authenticated ID in the memory 29 of the data server 10, the authenticator 25 permits an access of the first mobile phone 11 to any document data stored in the database 22.

By operating the menu key 33, a set of document data (e.g., a set of Word data containing ten pages of a document) may be selected from among many sets of document data stored in the database 22. Then the database controller 23 transmits the selected document data to the data converter 26. The data converter 26 converts the selected document data to first image data of a pixel in accordance with the set resolution of the LCD 34, so that the first image data may be suitably displayed on the LCD 34 (480×854 in pixel size). In the present example wherein the document data is assumed to be Word data consisting of ten pages, the first image data also consists of ten pages. Note that the same control as for Word data is executed with respect to Excel data, graphic data etc.

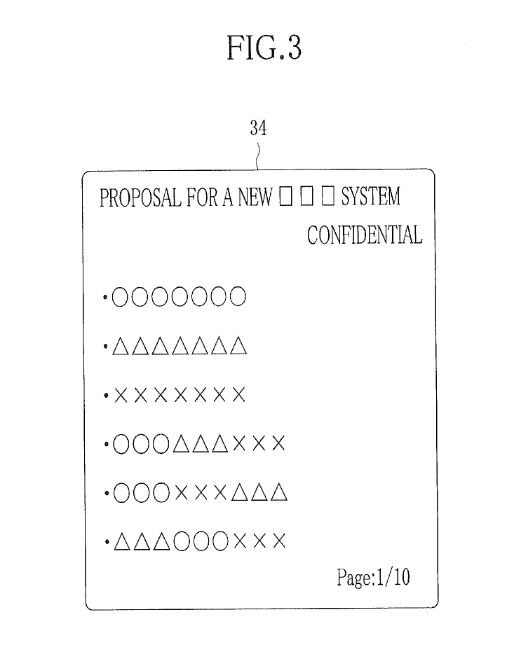

The first image data is transmitted through the communicator 21 and the Internet 15 to the first mobile phone 11. The first image data is received on the communicator 35, and the first page thereof is displayed on the LCD 34, as shown in FIG. 3.

The second mobile phone 12 is controlled in the same way as the first mobile phone 11 in the telephone mode. In the communication mode, however, the second mobile phone 12 is not authorized by the authenticator 25 and is not usually allowed to access and download the document data stored in the data server 10. In order to view the document data in the data server 10, the user of the second mobile phone 12 has to operate the menu key 33 to select one document from among many documents stored in the database 22. Then, the database controller 23 reads out a session ID of the selected document and transmits the read session ID from the communicator 21 to the second mobile phone 12. Upon receipt of the session ID from the data server 10, the second mobile phone 12 produces a request for access permit in the data producer 49 and transmits the same to the first mobile phone 11. This request for access permit includes the URL address of the database 22, the session ID of the requested document and ID data of the second mobile phone 12.

Upon receipt of the request for access permit from the second mobile phone 12, the first mobile phone 11 produces information for temporary access in the data producer 39 and transmits the information to the second mobile phone 12. The information for temporary access includes the URL address, the session ID of the requested document data and ID data of the first mobile phone 11, and is used for permitting a temporary access to the document data of which the session ID is included in the request for access permit.

Upon receipt of the information for temporary access, the second mobile phone 12 is connected to the data server 10 of the URL address as included in the information for temporary access over the Internet 15. At the same time, the second mobile phone 12 produces a request for temporary access, which includes the session ID of the document data, the ID of the first mobile phone 11, ID data of the second mobile phone 12 and data of set resolution of the LCD 44, in the data producer 49 and transmits the request for temporary access to the data server 10.

Upon receipt of the request for temporary access, the data producer 27 of the data server 10 produces information for judgment as to whether the request for temporary access is approved or not, and the data server 10 transmits the information for judgment to the first mobile phone 11 with reference to the ID of the first mobile phone 11 included in the request for temporary access. The information for judgment includes the session ID and the ID of the second mobile phone 12, which are included in the request for temporary access from the second mobile phone 12.

the CPU 36 of the first mobile phone 11 makes a judgment based on the information for judgment as to whether the request for temporary access is approved or not. The first mobile phone 11 produces a notice of grant of access in the data producer 39 if the session ID included in the information for judgment is identical to a session ID of a document of which image data is presently displayed on the first mobile phone 11, permitting a temporary access of the second mobile phone 12 to the requested document and instructing the data server 10 to send image data of the requested document to the second mobile phone 12. The notice of grant of access includes the session ID as included in the information for judgment from the data server 10 and the ID of the second mobile phone 12.

When the data server 10 receives the notice of grant of access, the CPU 24 of the data server 10 temporarily authorizes the second mobile phone 12 on the basis of the ID of the second mobile phone 12. The database controller 23 retrieves the document data as an origin of the first image data with reference to the session ID included in the notice of grant of access. Then the data converter 26 converts the retrieved document data to second image data representing ten pages of the retrieved document in accordance with the set resolution data of the LCD 44, the second image data being in compliance with the display format of the LCD 44 of the second mobile phone 12. Thus, the second image data represents the same document as the first image data sent to the first mobile phone 11, though the pixel number of the second image data is different from that of the first image data.

The communication detector 28 of the data server 10 detects the state of communication of the first mobile phone 11, to send the second image data to the second mobile phone 12 while the first mobile phone 11 is in communication with the second mobile phone 12. The CPU 46 of the second mobile phone 12 controls displaying the received second image data on the LCD 44.

On the other hand, if the session ID included in the information for judgment is not identical with the session ID of the document currently displayed on the first mobile phone 11, the first mobile phone 11 produces a notice of non-grant of access in the data producer 39 and transmits the same to the data server 10. Note that, even once the first mobile phone 11 has transmitted a notice of grant of access to the data server 10, when the user of the first mobile phone 11 terminates viewing the first image data or begins to browse other documents, the first mobile phone 11 will issue a notice of non-grant of access and transmit the same to the data server 10 because the session ID included in the information for judgment is not anymore identical with a session ID of the currently browsed document. When the notice of non-grant of access is received after once the notice of grant of access has been received with respect to the same case, the data server 10 invalidates the temporary access permit given to the second mobile phone 12, and forcibly quits the communication with the second mobile phone 12.

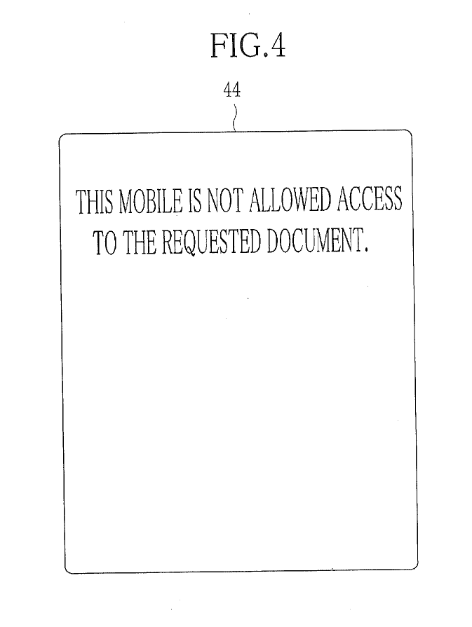

When the data server 10 receives the notice of non-grant of access, the data converter 26 reads out document data notifying non-grant of access from the database 22 and converts the same to image data of the format compatible with the LCD 44. The image data notifying non-grant of access is sent to the second mobile phone 12, and the CPU 46 of the second mobile phone 12 controls displaying the received image data on the LCD 44, as shown for example in FIG. 4.

When the communication detector 28 detects that the first mobile phone 11 gets out of communication with the second mobile phone 12, the data server 10 invalidates the temporary access permit of the second mobile phone 12 to the requested document, and forcibly quits communication with the second mobile phone 12.

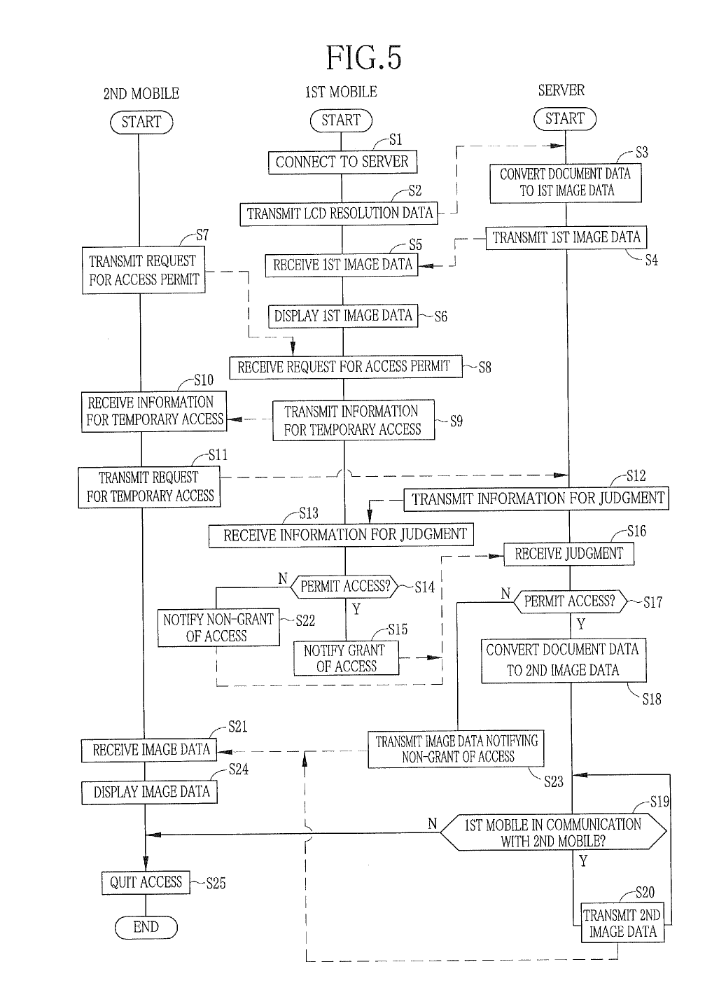

The operation of the first embodiment will be described below with reference to the flowchart of FIG. 5. First, the first mobile phone 11, which is authorized to access any document data in the database 22 of the data server 10, is switched to the communication mode, to connect with the data server 10 through the Internet 15 (step S1). Thereafter, the first mobile phone 11 is assumed to keep connection with the data server 10 in the following explanation.

In the communication mode, the first mobile phone 11 transmits the ID data thereof and the set resolution data of the LCD 34 to the data server 10 (S2). The ID data of the first mobile phone 11 is included in the authenticated ID data stored in the memory 29 of the data server 10, the authenticator 25 authenticates the first mobile phone 11 and permits the first mobile phone to access any documents in the database 22. The user of the first mobile phone 11 may select one document from among many documents in the database 22 by operating the menu key 33. On the basis of the set resolution data of the LCD 34, the data converter 26 of the data server 10 converts data of the selected document to first image data that is suitable for displaying on the LCD 34, i.e., 480×854-dot image data in the present embodiment (S3).

The first image data is sent from the data server 10 through the communicator 21 and the Internet 15 (S4) and is received on the communicator 35 of the first mobile phone 11 (S5). The CPU 36 of the first mobile phone 11 controls displaying the received first image data on the LCD 34, as shown for example in FIG. 3 (S6).

The second mobile phone 12, unauthorized to access the document data of the database 22 of the data server 10 [symbol] , is switched to the communication mode, to connect with the data server 10 through the Internet 15. Thereafter when the user operates the menu key 33 to select one document from among many documents in the database 22, the database controller 23 of the data server 10 reads the session ID of the selected document and transmits the read session ID from the communicator 21 to the second mobile phone 12. Then the second mobile phone 12 produces a request for access permit that includes the received session ID, an URL address of the selected document and the ID data of the second mobile phone 12, and transmits the request for access permit from the short-distance communicator 48 to the first mobile phone 11 (S7).

When the request for access permit from the second mobile phone 12 is received on the short-distance communicator 38 (S8), the first mobile phone 11 sends back information for temporary access to the second mobile phone 12. The information for temporary access includes the ID of the first mobile phone 11, the URL address and the session ID included in the request for access permit, and is used for temporarily permitting the second mobile phone 12 to access the document data identified by the session ID (S9).

Upon receipt of the information for temporary access (S10), the second mobile phone 12 makes a connection through the Internet 15 to the data server 10 on the basis of the URL address included in the information for temporary access. The second mobile phone 12 also produces a request for temporary access, which includes the session ID, the ID of the first mobile phone 11, the ID of the second mobile phone 12 and the set resolution data of the LCD 44, in a data producer 49, and transmits the request for temporary access to the data server 10 (S11).

Upon receipt of the request for temporary access, the data server 10 produces information for judgment executed in the first mobile phone as to whether this request should be approved or not; the information for judgment includes the session ID and the ID of the second mobile phone 12 and is transmitted to the first mobile phone 11 (S12).

Upon receipt of the information for judgment (S13), the first mobile phone 11 judges whether the second mobile phone should be permitted a temporary access to the requested document (S14). If the session ID included in the information for judgment is identical to the session ID of the document currently viewed on the first mobile phone 11 (“YES” in S14), the first mobile phone 11 permits the temporary access of the second mobile phone 12. If the session ID included in the information for judgment is not identical to the session ID of the document currently viewed on the first mobile phone 11 (“NO” in S14), the first mobile phone 11 does not permit the temporary access. Note that the same session ID is assigned to one document even while the document contains more than one page. Therefore, the temporary access of the second mobile phone is to be permitted if the user is viewing any page of the document identified by the same session ID as included in the information for judgment.

When the access is permitted (“YES” in S14), the first mobile phone 11 transmits a notice of a grant of access to the data server 10, granting the second mobile phone 12 a temporary access to the document data and instructing the data server 10 to send image data of the requested document data to the second mobile phone 12 (S15). The notice of grant of access includes the session ID and the ID of the second mobile phone 12.

When the data server 10 receives the notice of grant of access (S16 and “YES” in S17), the CPU 24 temporarily authorizes the second mobile phone 12 to access the document data on the basis of the ID of the second mobile phone 12. The database controller 23 retrieves the document data as the origin of the first image data on the basis of the session ID included in the notice of grant of access. Then the data converter 26 converts the retrieved document data to second image data suitable for the LCD 44 of the second mobile phone 12, i.e. 240×400-dot image data in the present embodiment, on the basis of the set resolution data of the LCD 44 included in the request for temporary access from the second mobile phone 12 (S18).

The communication detector 28 of the data server 10 detects the state of communication of the first mobile phone 11. When the communication detector 28 detects that the first mobile phone 11 is in communication with the second mobile phone 12 (“YES” in S19), the CPU 24 sends the second image data to the second mobile phone 12 (S20). The second image data is received on the communicator 45 of the second mobile phone 12 (S21).

When the second image data is received on the communicator 45 the CPU 46 of the second mobile phone 12 controls displaying the second image data on the LCD 44 (S24). Thus, the user of the second mobile phone 12 can view the same document data as the user of the first mobile phone 11 only when the first mobile phone 11 permits the second mobile phone 12 to access the document data, which assures the security of the document browsing system 2.

If, on the other hand, the first mobile phone 11 makes a judgment against the access of the second mobile phone 12 to the database 22 (“NO” in S14), the first mobile phone 11 notices the data server 10 of non-grant of access (S22). Even once the first mobile phone 11 has transmitted a notice of grant of access to the data server 10, when the user of the first mobile phone 11 terminates viewing the first image data or begins to browse other documents, the first mobile phone 11 will issue a notice of non-grant of access and transmit the same to the data server 10 because the session ID included in the information for judgment is not anymore identical with a session ID of the currently browsed document. When the notice of non-grant of access is received after once the notice of grant of access has been received with respect to the same case, the data server 10 invalidates the temporary access permit given to the second mobile phone 12, and forcibly quits the communication with the second mobile phone 12 (S25). When the data server 10 receives the notice of non-grant of access (S16 and “NO” in S17), the document data notifying non-grant of access is converted to image data suitable for the LCD 44, and the image data notifying non-grant of access is sent to the second mobile phone 12 (S23). As a result, the image data notifying the non-grant of access, as shown for example in FIG. 4, is displayed on the LCD 44 (S24).

When the communication detector 28 detects that the first mobile phone 11 gets out of communication with the second mobile phone 12 (“NO” in S19), the data server 10 invalidates the temporary access permit of the second mobile phone 12 to the document data, and forcibly quits communication with the second mobile phone 12 (S25). Thus, even after being permitted access to the same document data as the user of the first mobile phone 11 is currently viewing, the user of the second mobile phone 12 can view the document data only while the second mobile phone 12 is in communication with the first mobile phone 11 and the same document is being displayed on both the first and second mobile phones 11 and 12. Therefore, the security of the document browsing system is still more tightened.

### Second Embodiment

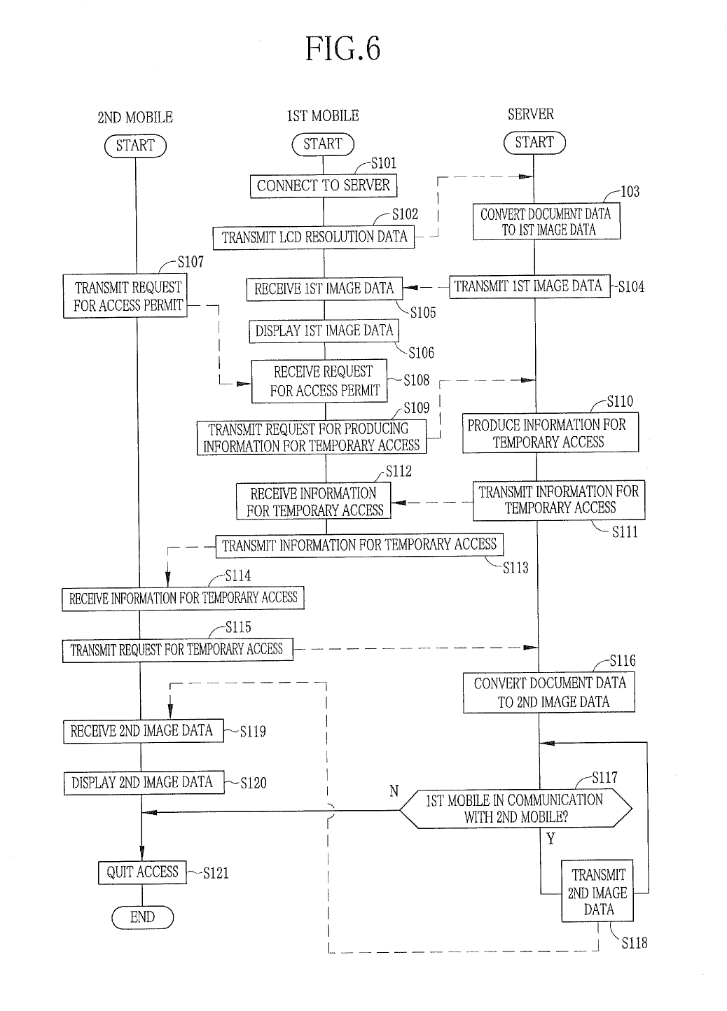

The second embodiment shown in FIG. 6 is configured to produce information for temporary access in the data server 10, wherein the same or equivalent components are designated by the same reference numbers as in the first embodiment and the detailed description of these components will be omitted to avoid redundancy.

The first mobile phone 11 is connected to the data server 10 through the Internet 15 when switched to the communication mode (S101). Following steps S102 to S107 are equivalent to the steps S2 to S7 of first embodiment; the description of these steps will be skipped.

When the first mobile phone 11 receives a request for access permit from the second mobile phone 12 (S108), the data producer 39 of the first mobile phone 11 produces a request for producing information for temporary access, requesting the data server 10 to produce information for temporary access, and the request for producing information for temporary access is transmitted to the data server 10 (S109). When the request for producing information for temporary access is received on the communicator 21 of the data server 10, the data producer 27 of the data server 10 produces information for temporary access (S110). The information for temporary access includes the URL address and the session ID of the requested document data and is transmitted to the first mobile phone 11 (S111). Note that the session ID included in the information for temporary access is effective only for an access from the second mobile phone 12.

When the first mobile phone 11 receives the information for temporary access (S112), the first mobile phone 11 transmits the received information for temporary access to the second mobile phone 12 (S113).

Upon receipt of the information for temporary access (S114), the second mobile phone 12 makes a connection to the data server 10 through the Internet 15 with reference to the URL address included in the information for temporary access, and produces a request for temporary access by including ID data of the second mobile phone 12 and the set resolution data of the LCD 44 of the second mobile phone 12. The information for temporary access is transmitted from the second mobile phone 12 to the data server 10 (S115).

When the data server 10 receives the request for temporary access, the CPU 24 temporarily authorizes the second mobile phone 12 on the basis of the ID of the second mobile phone 12 included in the request for temporary access. On the basis of the session ID included in the request for temporary access from the second mobile phone 12, the database controller 23 retrieves document data as the origin of the first image data that has been sent to the first mobile phone 11. The data converter 26 converts the retrieved document data to second image data in accordance with the set resolution data of the LCD 44 (S116). When the communication detector 28 detects that the first mobile phone 11 is in communication with the second mobile phone 12 (“YES” in S117), the second image data is sent to the second mobile phone 12 (S118), received on the communicator 45 (S119) and displayed on the LCD 44 of the second mobile phone 12 (S120).

When the first mobile phone 11 gets out of communication with the second mobile phone 12 (“NO” in S117) [symbol] , the CPU 24 of the data server 10 invalidates the temporary access permit of the second mobile phone 12 and forcibly quits communication with the second mobile phone 12 (S121).

### Third Embodiment

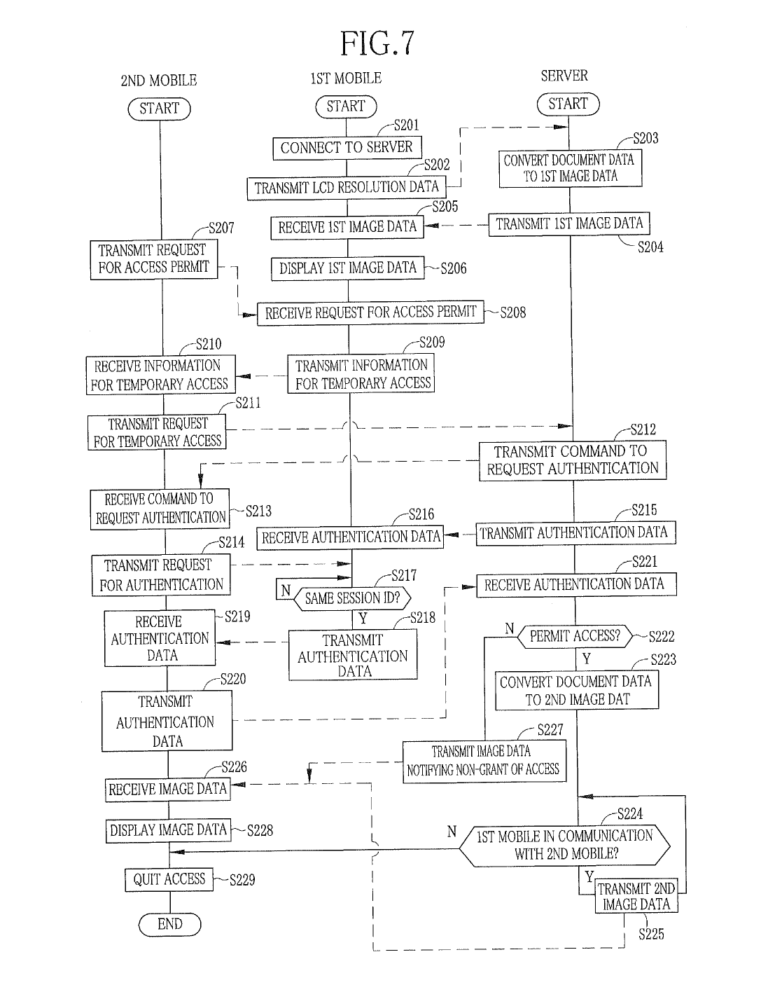

According to the third embodiment shown in FIG. 7, authentication data produced in the data server 10 is transmitted to the second mobile phone 12 by way of the first mobile phone 11, wherein the same or equivalent components are designated by the same reference numbers as in first embodiment, so that the detailed description of these components will be omitted.

In the communication mode, the first mobile phone 11 is connected to the data server 10 through the Internet 15 (S201). Following steps S202 to S211 are equivalent to the steps S2 to S11 of the first embodiment; the description of these steps will be skipped.

When the data server 10 receives a request for temporary access from the second mobile phone 12, a command to request authentication is produced in the data producer 27 of the data server 10. The command to request authentication is transmitted to the second mobile phone 12, instructing the second mobile phone 12 to transmit a request for authentication to the first mobile phone (S212).

In response to the command to request authentication (S213), the second mobile phone 12 produces a request for authentication in the data producer 49 and transmits the same to the first mobile phone 11 (S214). The request for authentication includes the URL address and the session ID of the document data to which the second mobile phone 12 has applied for an access.

After transmitting the command to request authentication to the second mobile phone 12, the data server 10 transmits authentication data to the first mobile phone 11 in order to give a temporary access permit to the second mobile phone 12 (S215). The authentication data includes the session ID and the ID of the second mobile phone 12 included in the request for temporary access. Thus, the first mobile phone 11 receives the authentication data from the data server 10 (S216) and, at the same time, the request for authentication from the second mobile phone 12. If the session ID included in the request for authentication is identical with the session ID included in the authentication data, and is also identical with a session ID of a document currently viewed on the first mobile phone 11 (“YES” in S217), the first mobile phone 11 transmits the authentication data to the second mobile phone 12 (S218).

Upon receipt of the authentication data (S219), the second mobile phone 12 transmits the authentication data to the data server 10 (S220).

When the data server 10 receives the authentication data from the second mobile phone 12 (S221), the CPU 24 makes a judgment as to whether the second mobile phone 12 is permitted a temporary access (S222). If the authentication data from the second mobile phone 12 is identical with the authentication data that the data server 10 has transmitted to the first mobile phone 11 (“YES” in S222), the second mobile phone 12 is authenticated and temporarily authorized to access the document data. If not (“NO” in S222), the second mobile phone 12 is not authenticated.

If the temporary access is permitted (“YES” in S222), the database controller 23 retrieves document data as the origin of the first image data on the basis of the session ID included in the request for temporary access from the second mobile phone 12. Then the data converter 26 converts the retrieved document data to the second image data in accordance with the set resolution data of the LCD 44 (S223). If the data communicator 28 detects that the first mobile phone 11 is in communication with the second mobile phone 12 (“YES” in S224), the second image data is sent to the second mobile phone 12 (S225) and received on the communicator 45 of the second mobile phone 12 (S226). The received second image data is displayed on the LCD 44 (S228).

If, on the other hand, the temporary access is not permitted (“NO” in S222), the data converter 26 converts the document data notifying non-grant of access to image data suitable for the LCD 44, and the image data notifying non-grant of access is sent to the second mobile phone 12 (S227), and is displayed on the LCD 44 (S228).

When the communication detector 28 of the data server 10 detects that the first mobile phone 11 gets out of communication with the second mobile phone 12 (“NO” in S224), the CPU 24 invalidates the temporary authorization of the second mobile phone 12, and forcibly quits communication with the second mobile phone 12 (S229).

In the above embodiments, the access to the document is permitted in the unit of one set of document data representative of the whole document, i.e. all pages of the document data. However, it may be possible to make the judgment on each individual page of the document data and send image data of each page to the temporarily-authorized mobile phone. In that case, a session ID should be given to each page of the document data, and image data of one page is sent to the temporarily-authorized mobile phone only while the one page is displayed on the authorized mobile phone.

In the above embodiments, data of set resolution of each LCD of the individual communication terminal is transmitted to the data server so that the data converter may convert document data to image data in accordance with the set resolution data. Alternatively, attribute data specific to each communication terminal may be transmitted to the data server so that the data converter may convert document data to image data on the basis of the attribute data. Such attribute data may include the name of manufacturer and the model number of the communication terminal. In this embodiment, the data server should register data of respective set resolutions of various communication terminals in the memory, so that the data converter may read out the data of set resolutions in association with the attribute data received from the requesting communication terminal, to convert document data to image in accordance with the read data.

Although the present invention have been described with reference to the illustrated embodiments wherein two mobile phones are involved in the document browsing system, the number of communication terminals may change as appropriate. For example, first to fifth mobile phones may be involved in the system of the present invention, among which the first mobile phone is authorized and the second to fifth mobile phones are not authorized. In that case, the first mobile phone and the data server may apply the same processes to each of the second to fifth mobile phones as applied to the second mobile phone in the above embodiments. It should be understood that the embodiments of the present invention have been described for illustrative purposes only. Those skilled in the art will appreciate that various modifications, additions and substitutions are possible without departing from the scope and spirit of the invention as disclosed in the accompanying claims.

What is claimed is:

1. A document browsing system comprising a data server and multiple communication terminals having image data displaying function,
A. the communication terminals comprising:
an authorized communication terminal that is authorized by an authenticator of the data server; and
an unauthorized communication terminal that is not authorized by the authenticator; and
B. the data server comprising:
a storage device storing document data;
a data converter for converting the document data to image data;
the authenticator for authentication and authorization of the communication terminals;
a communicator for communicating with the multiple communication terminals and sending the image data to the authorized communication terminal; and
a communication detector for detecting the state of communication between the communication terminals, wherein
C. the authorized communication terminal transmits information for temporary access to the unauthorized communication terminal upon receipt of a request for access permit from the unauthorized communication terminal requesting an access to the document data, the information for temporary access being used for granting the unauthorized communication terminal a temporary access permit, and exchanges information with the data server to decide whether the unauthorized communication terminal should be allowed to access the document data;
the unauthorized communication terminal transmits the request for access permit to the authorized communication terminal when requesting an access to the document data, produces a request for temporary access on the basis of the information for temporary access as received from the authorized communication terminal, and transmits the request for temporary access to the data server; and
the data server sends image data of the same document data as sent to the authorized communication terminal to the unauthorized communication terminal if the temporary access of the unauthorized communication terminal to the document data is permitted on the basis of the information exchanged between the data server and the authorized communication terminal when the request for temporary access is received from the unauthorized communication terminal and the communication detector detects that the authorized communication terminal is in communication with the unauthorized communication terminal, and the data server invalidates the temporary access permit given to the unauthorized communication terminal when the communication detector detects the end of communication between the authorized communication terminal and the unauthorized communication terminal.

2. The document browsing system as recited in claim 1, wherein
A1. the authorized communication terminal comprises:
a first data producer for producing the information for temporary access upon receipt of the request for access permit from the unauthorized communication terminal;
a judging section for judging whether to grant the unauthorized communication terminal the temporary access permit or not; and
a first controller for controlling the authorized communication terminal to transmit the information for temporary access to the unauthorized communication terminal and transmit the judgment by the judging section to the data server;
A2. the unauthorized communication terminal comprises:
a second data producer for producing the request for access permit and, upon receipt of the information for temporary access from the authorized communication terminal, the request for temporary access; and
a second controller for controlling the unauthorized communication terminal to transmit the request for access permit to the authorized communication terminal and transmit the request for temporary access to the data server; and
B. the data server further comprises:
a third data producer for producing information for judgment by the judging section in the authorized communication terminal upon receipt of the request for temporary access from the unauthorized communication terminal; and
a third controller for controlling the data server to transmit the information for judgment to the authorized communication terminal, send the image data of the document data to the unauthorized communication terminal when the judgment received from the authorized communication terminal permits the access and the authorized communication terminal is in communication with the unauthorized communication terminal, and invalidate the temporary access permit at the end of communication between the authorized communication terminal and the unauthorized communication terminal.

3. The document browsing system as recited in claim 2, wherein the data server transmits image data notifying non-grant of access to the unauthorized communication terminal when the judgment received from the authorized communication terminal refuses the access.

4. The document browsing system as recited in claim 2, wherein,
the data server transmits a session ID of the document data, to which the unauthorized communication terminal is requesting the access, to the unauthorized communication terminal;
the unauthorized communication terminal includes the session ID in the request for access permit when transmitting the request for access permit to the authorized communication terminal;
the authorized communication terminal produces the information for temporary access including the session ID that is included in the request for access permit and ID data of the authorized communication terminal, and transmits the information for temporary access to the unauthorized communication terminal;
the unauthorized communication terminal produces the request for temporary access including the session ID, the ID data of the authorized communication terminal and ID data of the unauthorized communication terminal on the basis of the information for temporary access, and transmits the request for temporary access to the data server;
the data server transmits the information for judgment including the session ID included in the request for temporary access the authorized communication terminal; and
the judging section permits the access if the session ID included in the information for judgment is identical with a session ID of document data which the authorized communication terminal is currently accessing, and refuses the access if the session IDs are not identical.

5. The document browsing system as recited in claim 1, wherein,
A1. the authorized communication terminal comprises:
a first data producer for producing a request for producing information for temporary access, which is requesting the data server to produce the information for temporary access, upon receipt of the request for access permit from the unauthorized communication terminal; and
a first controller for controlling the authorized communication terminal to transmit the request for producing information for temporary access from the authorized communication terminal to the data server and, upon receipt of the information for temporary access from the data server, transmit the information for temporary access from the authorized communication terminal to the unauthorized communication terminal;
A2. the unauthorized communication terminal comprises:
a second data producer for producing the request for access permit and, upon receipt of the information for temporary access from the authorized communication terminal, the request for temporary access; and
a second controller for controlling the unauthorized communication terminal to transmit the request for access permit to the authorized communication terminal and transmit the request for temporary access to the data server; and
B. the data server further comprises:
a third data producer for producing the information for temporary access upon receipt of the request for producing information for temporary access from the authorized communication terminal; and
a third controller for controlling the data server to transmit the information for temporary access from the data server to the authorized communication terminal, grant the unauthorized communication terminal a temporary access permit upon receipt of the request for temporary access from the unauthorized communication terminal, send the image data of the document data to the unauthorized communication terminal only while the authorized communication terminal is in communication with the unauthorized communication terminal.

6. The document browsing system as recited in claim 1, wherein,
A1. the authorized communication terminal comprises:
a first data producer for producing the information for temporary access upon receipt of the request for access permit from the unauthorized communication terminal; and
a first controller for controlling the authorized communication terminal to transmit the information for temporary access from the authorized communication terminal to the unauthorized communication terminal and, upon receipt of authentication data from the data server and a request for authentication from the unauthorized communication terminal, transmit the authentication data to the unauthorized communication terminal;
A2. the unauthorized communication terminal comprises:
a second data producer for producing the request for access permit and the request for authentication, and the request for temporary access upon receipt of the information for temporary access from the authorized communication terminal; and
a second controller for controlling the unauthorized communication terminal to transmit the request for access permit and the request for authentication to the authorized communication terminal, and the request for temporary access and the authentication data as received from the authorized communication terminal to the data server; and
B. the data server further comprises:
a third data producer for producing the authentication data and a command to request authentication, commanding the unauthorized communication terminal to transmit the request for authentication to the authorized communication terminal; and
a third controller for controlling the data server to transmit the command to request authentication to the unauthorized communication terminal upon receipt of the request for temporary access from the unauthorized communication terminal, transmit the authentication data to the authorized communication terminal and, if the authentication data from the unauthorized communication terminal is identical with the authentication data as transmitted from the data server to the authorized communication terminal, grant the unauthorized communication terminal a temporary access permit and send the image data of the document data to the unauthorized communication terminal only while the authorized communication terminal is in communication with the unauthorized communication terminal.

7. The document browsing system as recited in claim 1, wherein,
the request for access permit includes a session ID of the document data the unauthorized communication terminal is requesting access, and ID data of the unauthorized communication terminal;
the information for temporary access includes the session ID and ID data of the authorized communication terminal; and
the request for temporary access includes the session ID, the ID data of authorized communication terminal, the ID data of the unauthorized communication terminal, and set resolution data of the unauthorized communication terminal, wherein,
the data server converts the document data to image data in accordance with the set resolution data and sends the image data to the unauthorized communication terminal when the access of the unauthorized communication terminal to the document data is permitted.

8. A method of controlling a document browsing system that comprises a data server and multiple communication terminals having image data displaying function, the data server comprising a storage device storing document data, a data converter for converting the document data to image data, an authenticator for individual authentication and authorization of the communication terminals, a communicator for communicating with the multiple communication terminals and sending the document data as image data to a communication terminal authorized by the authenticator, and a communication detector for detecting the state of communication between the communication terminals,
the controlling method comprising:
producing a request for access permit, requesting an access to the document data, at an unauthorized communication terminal that is not authorized by the authenticator;
transmitting the request for access permit to the authorized communication terminal;
producing information for temporary access on the basis of the request for access permit from the unauthorized communication terminal, in order to grant the unauthorized communication terminal a temporary access permit;
transmitting the information for temporary access from the authorized communication terminal to the unauthorized communication terminal;
producing a request for temporary access on the basis of the information for temporary access at the unauthorized communication terminal;
transmitting the request for temporary access to the data server;
judging whether to permit the unauthorized communication terminal a temporary access to the document data on the basis of information exchanged between the data server and the authorized communication terminal;
detecting the state of communication of the authorized communication terminal at the data server;
sending image data of the same document data as sent to the authorized communication terminal to the unauthorized communication terminal if the temporary access of the unauthorized communication terminal to the document data is permitted and the communication detector detects that the authorized communication terminal is in communication with the unauthorized communication terminal when the data server receives the request for temporary access from the unauthorized communication terminal; and
invalidating the temporary access permit given to the unauthorized communication terminal when the communication detector detects the end of communication between the authorized communication terminal and the unauthorized communication terminal.

9. The method of controlling the document browsing system as recited in claim 8, further comprising:
producing the information for temporary access at the authorized communication terminal;
producing information for judgment on the basis of the request for temporary access at the data server;
transmitting the information for judgment from the data server to the authorized communication terminal;
making a judgment at the authorized communication terminal, on the basis of the information for judgment, as to whether the unauthorized communication terminal should be permitted an access to the document data;
transmitting the judgment from the authorized communication terminal to the data server; and
granting the unauthorized communication terminal a temporary access permit if the judgment permits the access.

10. The method of controlling the document browsing system as recited in claim 8, further comprising:
producing at the authorized communication terminal a request for producing information for temporary access on the basis of the request for access permit from the unauthorized communication terminal;
transmitting the request for producing information for temporary access from the authorized communication terminal to the data server;
producing the information for temporary access at the data server on the basis of the request for producing information for temporary access;
transmitting the information for temporary access from the data server to the authorized communication terminal;
transmitting the information for temporary access from the authorized communication terminal to the unauthorized communication terminal;
transmitting, on the basis of the information for temporary access, the request for temporary access from the unauthorized communication terminal to the data server; and
granting the unauthorized communication terminal a temporary access permit when the data server receives the request for temporary access.

11. The method of controlling the document browsing system as recited in claim 8, further comprising:
producing the information for temporary access at the authorized communication terminal on the basis of the request for access permit from the unauthorized communication terminal;
transmitting the information for temporary access from the authorized communication terminal to the unauthorized communication terminal;
producing at the dater server a command to request authentication, commanding the unauthorized communication terminal to transmit a request for authentication to the authorized communication terminal, on the basis of the request for temporary access;
transmitting the command to request authentication from the data server to the unauthorized communication terminal;
producing the request for authentication at the unauthorized communication terminal and transmitting the request for authentication to the authorized communication terminal in response to the command to request authentication;
producing authentication data at the data server on the basis of the request for temporary access;
transmitting the authentication data from the data server to the authorized communication terminal;
transmitting the authentication data from the authorized communication terminal to the unauthorized communication terminal if a session ID included in the request for authentication from the unauthorized communication terminal is identical with a session ID of the document data included in the authentication data and a session ID of document data the authorized communication terminal is presently accessing;
transmitting the authentication data from the unauthorized communication terminal to the data server; and
granting the unauthorized communication terminal a temporary access permit if the authentication data received from the unauthorized communication terminal is identical with the authentication data as transmitted from the data server to the authorized communication terminal.

12. A data server communicable with multiple communication terminals having data displaying function, the data server comprising:
a storage device storing document data;
a data converter for converting the document data to image data;
an authenticator image data for individual authentication and authorization of the multiple communication terminals;
a communicator for communicating with the multiple communication terminals and transmitting the image data to a communication terminal authorized by the authenticator;
a temporary authorizer for authorizing, upon receipt of a request for temporary access to the document data from an unauthorized communication terminal that is not authorized by the authenticator, as a temporarily-authorized communication terminal;
a communication detector for detecting the state of communication between the communication terminals; and
a controller for sending image data of the same document data as sent to the authorized communication terminal to the temporary unauthorized communication terminal when the communication detector detects that the temporary authorized communication terminal is in communication with the authorized communication terminal, and invalidating the temporary authorization when the communication detector detects that the temporarily-authorized communication terminal does not communicate with the authorized communication terminal.

13. The data server as recited in claim 12, wherein the temporary authenticator authorizes the unauthorized communication terminal as a temporarily-authorized communication terminal when the data server receives ID data of the unauthorized communication terminal and the request for temporary access from the unauthorized communication terminal and also receives an access permit to the document data in association with the ID data of the unauthorized communication terminal from the authorized communication terminal.

14. The data server as recited in claim 12, comprising:
a data producer for producing information for temporary access in order to permit a temporary access of the unauthorized communication terminal to the document image data, the information for temporary access being transmitted through the authorized communication terminal to the unauthorized communication terminal, wherein,
the temporary authenticator authorizes the unauthorized communication terminal as a temporarily-authorized communication terminal when the data server receives the request for temporary access from the unauthorized communication terminal, the request for temporary access being based on the information for temporary access and including ID data of the unauthorized communication terminal.

15. The data server as recited in claim 12, comprising:
a data producer for producing authentication data when the data server receives ID data of the unauthorized communication terminal and the request for temporary access from the unauthorized communication terminal, wherein,
the authentication data is transmitted to the authorized communication terminal, transferred to the unauthorized communication terminal if the authentication data is admitted to the authorized communication terminal, and transmitted from the unauthorized communication terminal to the data server; and
the temporary authenticator authorizes the unauthorized communication terminal as a temporarily-authorized communication terminal when authentication data received from the unauthorized communication terminal is identical with the authentication data as transmitted to the authorized communication terminal.
